(19) United States
(12) Patent Application Publication
(10) Pub. No.: US 2010/0024646 A1
(43) Pub. Date: Feb. 4, 2010

(54) Air Scrubber with Folded Air Flow

(76) Inventor: David L. Brookman, Oriental, NC (US)

Correspondence Address: JAY CHESAVAGE, 3833 MIDDLEFIELD, PALO ALTO, CA, 94303, US

(21) Appl. No.: 12/185,469

(22) Filed: Aug. 4, 2008

(51) Int. Cl. B01D 47/02

(52) U.S. Cl. 95/154; 96/276; 95/213

(57) ABSTRACT

A scrubber has a return air inlet and an outside air inlet receiving contaminated air into a passageway with an aspect ratio greater than 4, the passageway surfaces wetted by a fluid disposed from a pre-wetter. The passageway has a first section whereby contaminated air travels downward toward the fluid surface of a main reservoir, and is thereafter directed upward and through a scrub reservoir having a plurality of apertures. The contaminated air mixes with the fluid of the scrub reservoir, forming a mixture of contaminants and fluid which are returned to the main reservoir, and also producing clean air with airborne fluid droplets which are passed to a demister pad for separating the fluid droplets and returning them to the reservoir, and the cleaned air is provided to a clean air outlet. A blower moves the air through the scrubber, and a pump pressurizes fluid from the main reservoir and provides it to the pre-wetter and to the scrub reservoir, such as through a gutter reservoir.

### FIELD OF THE INVENTION

The present invention relates to an air scrubber and cleaner. More particularly, the present invention relates to air scrubbers and air cleaners for indoor use.

### BACKGROUND OF THE INVENTION

Industrial air scrubbers are well known in the art of pollution control. U.S. Pat. Nos. 4,388,090 and 5,938,820 describe the mixing of polluted air with a fluid, which is placed into a series of settling tanks for isolation of the pollutants. U.S. Pat. Nos. 4,227,895, 5,085,673, 5,846,303 and 5,292,353 provide an air scrubber by impinging the contaminated air onto a series of paths and baffles which are each wetted either directly, or by the wetted contamination solution which is the form of an aerosol. U.S. Pat. No. 5,641,338 describes a scrubber which includes a water tray for passing contaminated air through water.

### OBJECTS OF THE INVENTION

A first object of this invention is an apparatus for moving air mixed with contaminants from an air inlet to an air outlet through a folded passageway, the passageway introducing a wetting fluid into the inlet duct with the contaminated air and forming a downward directed flow of pre-wet air containing contaminants, the downward directed flow thereafter encountering a lateral deflector which causing the air and contaminants to interact with the wetted passageway walls and be directed towards the liquid surface of a main reservoir, the air flow direction thereafter changing upward to impinge on the bottom perforated plate of a scrubber, the opposing top surface of the perforated plate forming a scrubber reservoir through which jets of contaminated air pass to further interact with and pass through the scrubber reservoir fluid to form a scrubber discharge containing fluid and contaminants and cleaned air with fluid droplets, the scrubber reservoir filled by the overflow from a gutter reservoir, the gutter reservoir filled by a gutter supply, the scrubber output coupled to a demister for directing the cleaned air to an air outlet and aggregating any fluid droplets which pass through the media of the demister and directing the aglomerated fluid droplets back to the scrubber reservoir and main reservoir, where the fluid may contain water and a surfactant.

A second object of the invention is a process for removing contaminants from air, the process having:

a first step of directing the contaminated air through a passageway having an aspect ratio greater than 4, the surface of the passageway wetted by a pre-wetter such as a pipe containing apertures and pressurized by a fluid, a second step of directing the contaminated air downward towards the liquid surface of a main reservoir containing the fluid;

a third step, after downward direction of the contaminated air toward the liquid surface, of directing the contaminated air upward to the bottom surface of a scrubber;

a fourth step of passing the contaminated air from the bottom surface of the scrubber through a plurality of apertures into a scrub reservoir, thereby forming jets of contaminated air which pass through the plurality of apertures of the bottom surface of the scrubber and creating an efficient fluid to contaminated air contact, thereafter passing through the liquid of the scrub reservoir to form a scrubber discharge containing a mixture of contaminants mixed with fluid and cleaned air mixed with fluid droplets;

a fifth step of passing the cleaned air mixed with fluid droplets to a demister, the demister separating the cleaned air from the fluid droplets, the cleaned air passing to an air outlet, with the fluid and contaminants returning to the main reservoir,

where the fluid reservoir contents are pumped to the pre-wetter and also to the scrub reservoir by filling a gutter reservoir which spills over into the scrub reservoir, and where said reservoir fluid is water mixed with a surfactant.

### SUMMARY OF THE INVENTION

The present invention removes particulates and other contaminants from indoor or outdoor residential air, and is mountable in the aperture of a room open to the outside air, such as a window. An air inlet accepts contaminated air such as a mixture of return contaminated air from inside the room and/or external contaminated air from outside the room and directs the inlet air downward through a passageway and past a pre-wetter for spraying a fluid throughout the passageway. After the pre-wetter, a lateral deflector increases the interaction between the contaminated air the wetted surfaces of the passageway. In a preferred embodiment, the aspect ratio of the cross section of the passageway orthogonal to air flow is increased to enhance the surface area, which enhanced surface area provides improved capture of particles, fibers, and other large contaminants along the wetted passageway walls, and the fluid comprises water mixed with a surfactant which reduces water surface tension and improves contaminant collection efficiency. The wetted inlet passageway directs the air downward towards the liquid surface of the main reservoir, after which the air is directed upward through a scrub tray reservoir which has a lower surface containing a plurality of apertures. The upward flowing air is directed through the plurality of apertures, thereby forming a plurality of jets of contaminated air through the scrub reservoir, which maximizes the interaction of contaminants with the fluid, thereby putting the contaminants in solution and forming a scrubber discharge containing fluid with contaminants, and cleaned air mixed with fluid droplets. The use of water and a surfactant to form the fluid results in increased contaminated air and fluid interaction, thereby capturing most of the contaminants in the fluid, with the fluid and contaminates returning to the reservoirs and the cleaned air mixed with fluid droplets passing through a scrubber chamber to a demister pad, which captures and agglomerates the fluid droplets and directs them back to the main reservoir or the scrubber reservoir, while passing the cleaned air to an air outlet. One surface of the demister pad is proximal to a distribution grid, which comprises a perforated metal screen for equalizing the air flow through the demister pad. Air flow through the scrubber is provided by a blower which forces the cleaned air out of the device and into the room. In one embodiment of the invention, the fluid used by the scrubber comprises water mixed with a small amount of surfactant, and in one preferred embodiment, the surfactant is introduced to the main reservoir from a surfactant reservoir within the scrubber, such that the surfactant may be added when filling the main reservoir with water, or at any time during operation of the scrubber, as required.

The main reservoir is coupled to a recirculating pump and distribution plumbing, which collects fluid from the main reservoir above a contaminant settling area and delivers it to the pre-wetter and gutter supply which couples to the scrub reservoir through a gutter reservoir. A fill mechanism regulates the water level of the main reservoir, and a set of overflow drains and valves permits emptying and refilling the unit periodically. Valves for the pre-wetter and gutter supply allow regulation of fluid flow to these respective delivery points.

One embodiment of the invention includes a scrub divider which provides fractional capacity for the scrub reservoir, such that a fraction of the air volume passes through an active scrub reservoir containing fluid, and the remainder passes through a scrub reservoir without fluid.

### BRIEF DESCRIPTION OF THE DRAWINGS

FIG. 1 shows a composite side section view of an air scrubber.

FIG. 2 shows a composite front section view of the scrubber of FIG. 1.

FIG. 3 shows a composite front section view of the scrubber of FIG. 1, which section passes through a surfactant reservoir and a fill chamber.

### DETAILED DESCRIPTION OF THE INVENTION

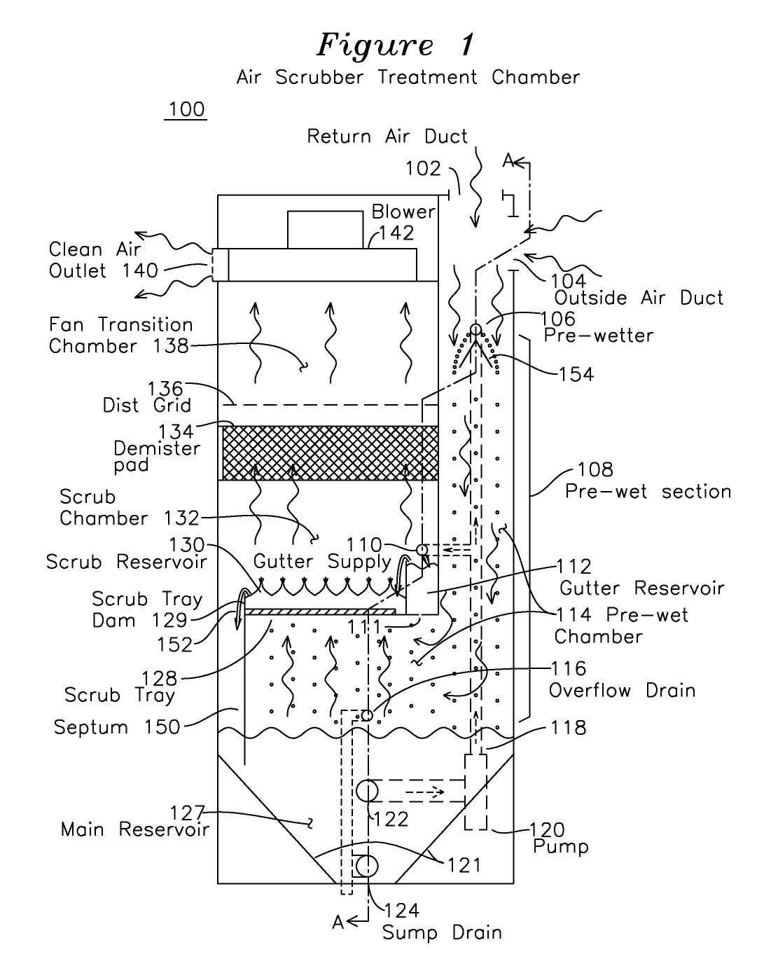

FIG. 1 shows one embodiment of an air scrubber 100. Contaminated indoor air from a return air duct 102 and/or contaminated outside air from an outside air duct 104 are regulated such as by a damper (not shown) and combine in a passageway, and are presented to a pre-wetter 106, which may be a circular pipe with apertures which produce a sideways fluid spray pattern to wet the surface of the passageway. A lateral deflector 154 causes turbulence and increased air velocity, thereby improving the interaction of contaminated air with the wetted surfaces of the passageway, and the pre-wetter 106 also washes collected contaminates into the main reservoir 127. In one embodiment of the invention, the pre-wetter includes a PVC pipe of 0.375 inch diameter with 0.188 inch diameter holes drilled with 4 inch spacing, and the lateral deflector reduces the passageway in one region after pre-wetting to causes the air velocity in the passageway to reach in excess of 1600 feet per minute, thereby increasing the turbulence of contaminated air in the passageway and enhancing the mixing of contaminated air with the pre-wet fluid and providing continuous wetting of the walls of the passageway for removal of contaminants. The aspect ratio of the inlet duct is preferably large, such that a maximum surface area is wetted and presented to the contaminated air passing through it, which captures large particles, fibers, and other contaminants, which are washed into the main reservoir 127 below. The preferred aspect ratio of the passageway is greater than 4, and in one embodiment of the invention, the cross section of the passageway is 20 inches by 2.5 inches, thereby producing an aspect ratio of 8. A blower 142 at the clean air outlet 140 ensures the continuous movement of air through the cleaner 100, such as at a rate of 400 CFM to 500 CFM, preferably in the range of 450 CFM for the example passageway size. Contaminated air which passes through the pre-wetter 106 is directed downward by the forced air flow at a velocity of 750 to 850 feet per minute, with large contaminates swept onto the fluid surface of the main reservoir 127 at the region of transition from downward flow to upward flow, where the large droplets and contaminates are captured by the fluid surface and sink towards the sump drain 124, where the bottom of the main reservoir 127 has tapered sides 121 leading to the sump drain 124. Pre-wet contaminated air is directed downwards toward the liquid surface of main reservoir 127, thereafter changing direction 180 degrees from a downward flow to an upward flow to the bottom of scrub tray 128, which comprises a perforated metal plate with a scrub reservoir above. The 180 degree change of direction causes contamination particle sorting, where the greater mass wetted contamination particles traveling downward continue to the reservoir 127 surface, and the lower mass contamination particles and air continue upward where they form jets as they travel through the perforated bottom 128 of the scrub reservoir 130, the jets passing through the scrubber with a velocity of 640 to 720 feet per minute. The scrub reservoir 130 fills on one side from the spillover from a gutter reservoir 112 and drains on the opposite side from a scrub tray dam 129, the fluid cascading into the main reservoir 127 and past a septum 150, which separates the pre-wet chamber 114 from the scrub chamber 132. In the best mode of the invention, the bottom perforated surface of the scrub tray 128 is kept wetted, and this wetting function is performed by a small aperture 111 in the bottom of the gutter reservoir 112, as well as the increased moisture content of the pre-wet air which enters from the bottom surface.

Contaminated air which passes through the apertures of the scrub tray 128 forms into a plurality of air jets which are forced to interact with fluid in the scrub reservoir 130, putting the contaminates into solution. In the preferred embodiment, the fluid is water with a surfactant which improves collection efficiency by reducing surface tension and allowing contaminants to easily form solutions with the fluid. Additionally, the use of a surfactant allows the capture of contaminants such as vaporized hydrocarbons which constitute oils and grease, and aids in the capture of odors and sub-micron particulates such as smoke. Preferred surfactants include potassium pyrophosphate, and in one embodiment, the fluid is approximately one part potassium pyrophosphate surfactant in 500 parts water. The contaminated air jets mix and aerate in the scrub chamber 132, where the object of the interaction is to maximize the amount of particulate matter and contamination transferred from the contaminated air to the fluid, and forming a scrubber discharge which consists of a mixture of contaminants and fluid 152, which pass over the scrub tray dam 129, and a mixture of air and fluid droplets, which are directed through the scrub chamber 132 to the demister pad 134. Because of the high collection efficiency of the scrub reservoir 130, the bulk of the captured contaminants 152 of the fluid mixture pass over the scrub tray dam 129 into the main reservoir, which is separated from the pre-wet chamber 114 by septum 150. The contaminants settle in the tapered bottom of the main reservoir 127, near the sump drain 124.

The scrubber chamber 132 is coupled to demister pad 134 which provides a matrix of material for capturing fluid droplets and aggregating the droplets into larger agglomerates which drip back to the main reservoir 127 or scrub reservoir 130, with the cleaned air passing to outlet 140. The demister pad 134 operates in conjunction with a distribution grid 136, which ensures uniform flow through the demister pad 134. The distribution pad 136 contains an array of apertures sufficient to cause a drop of air pressure across the distribution grid 136 which is selected to be slightly greater than the air pressure drop across the demister pad 134. In this manner, the airflow uniformity across the surface of the demister 134 is regulated by the distribution grid 136 rather than the demister pad 134, which would otherwise be non-uniform because of density variations and other factors related to the demister pad 134. A fan distribution chamber 138 is defined by the output side of the demister pad and has one side coupled to the fan or blower 142, which ejects cleaned air through the clean air outlet 140.

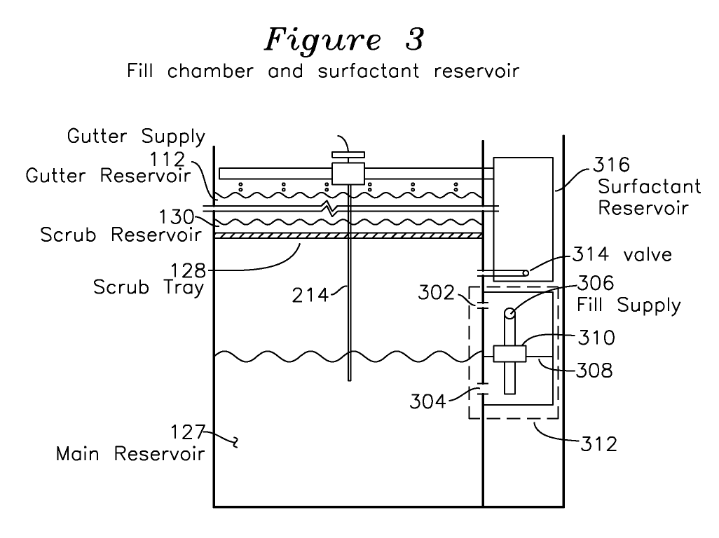

A fluid distribution system collects fluid from the main reservoir 127 using a fluid inlet 122 located above a settling sump drain 124, delivers the fluid to pump 120, which pressurizes the fluid and delivers it to pre-wetter 106 through regulation valve 204 and to gutter supply 110 through gutter supply regulation valve 206. The valves 204 and 206 can be set to provide optimum flow levels for cleaning, and an optional valve 216 may be used to fractionally reduce capacity, as will be described later. An overflow outlet 116 directs overfill from the reservoir to a drain, as does sump drain 124 which is used for cleaning and maintenance operations. A fill unit 312 shown in FIG. 3 is preferably isolated from the turbulent flow and surface waves of the main reservoir 127 through a vent aperture 302 and fill aperture 304, thereby sensing average water level 308 and operating a float 310 coupled through a fill valve (not shown) to a fill source to maintain the fluid level of the main reservoir 127 at an optimum level for operation. FIG. 3 also shows a surfactant reservoir 316 which provides surfactant to the main reservoir 127, such as by manual or automatic valve 314.

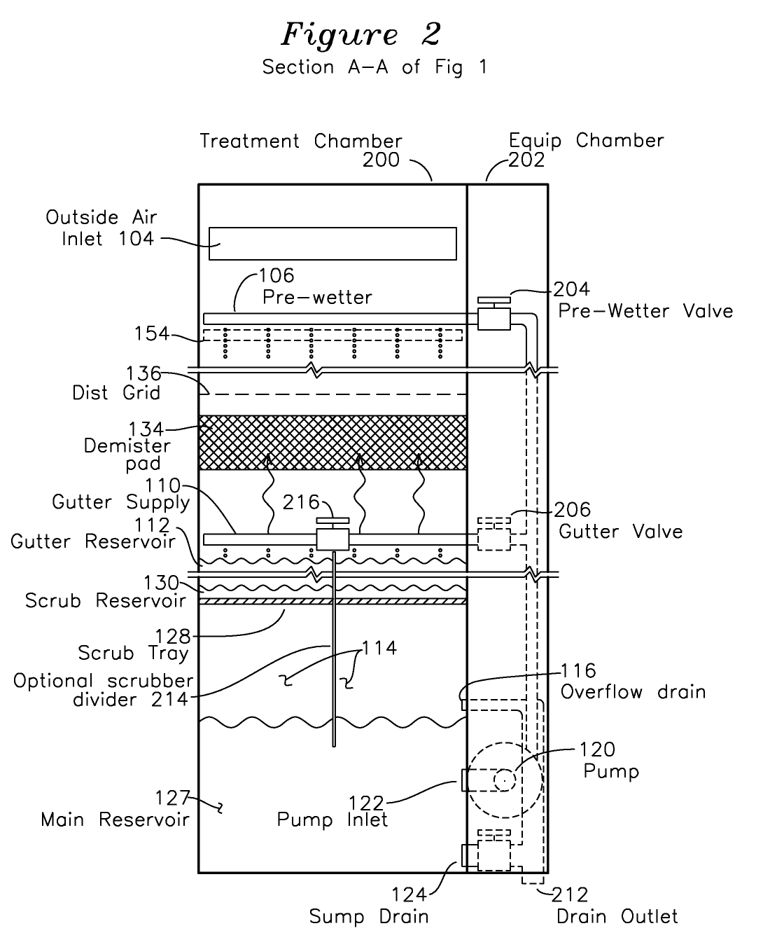

FIG. 2 shows a composite section A-A taken from FIG. 1, and includes other structures outside the section line shown in dashed outline for reference. The section A-A of FIG. 1 passes through part of the pre-wet chamber 114 including pre-wetter 106, then to the gutter reservoir 112 and scrub tray 128, through the pre-wet chamber 114 and through the main reservoir 127. FIG. 2 also shows the cleaner divided into a treatment chamber 200 containing the previously described structures related to air scrubbing and cleaning, and equipment chamber 202, which includes structures related to control and distribution of the cleaner. Section A-A of FIG. 1 as viewed in FIG. 2 shows the outside air inlet 104, the pre-wetter 106, which may be a section of pipe having a plurality of apertures for the generation of streams of fluid or fluid droplets. The section A-A which crosses to the fan distribution chamber 138 shows distribution grid 136, demister pad 134, gutter supply pipe 110, which may be of any length as required to fill the gutter reservoir 112, and scrub reservoir 130 above scrub tray 128 with main reservoir 127 below. FIG. 2 also shows the pre-wetter valve 204 for regulating the flow of the pre-wetter 106 and gutter valve 206 for regulating the gutter flow.

In one embodiment of the invention, the cleaner capacity and humidification (and related evaporative cooling) of air through the scrubber can be fractionally controlled by varying the active width of the gutter reservoir and scrub reservoir. In this configuration, an optional gutter scrub divider 214 divides the gutter reservoir 112, scrub reservoir 130, and optionally pre-wet chamber 114 into an “active” part which is fed with fluid, and a “passive” part which is shut off from fluid, such as by scrub tray divider valve 216. When scrub tray divider valve 216 is shut off, the left portion of the scrub reservoir 130 is not filled and is operated in a bypass mode, and the right side of the gutter reservoir 112 and scrub tray 128 is filled with fluid and operates as described earlier. This configuration may be useful to reduce humidity generated by the scrubbing operation, or to reduce the evaporative cooling effect of the scrub reservoir 130, and the placement of one or more scrub dividers 214 may be done in any manner across the span of the scrub reservoir 130.

In one embodiment of the invention, the fluid which is provided to the pre-wet section, gutter reservoir, scrub reservoir, and main reservoir is pumped from the main reservoir.

In one embodiment of the invention, the fluid provided to the scrubber reservoir is water mixed with a surfactant. The attributes of the surfactant which produces best removal of contaminants is the reduction of surface tension of the base fluid the surfactant is mixed with. For the case of a water based fluid, the preferred surfactant is one part potassium pyrophosphate to 500 parts water. This surfactant concentration may be increased or decreased by an order of magnitude (varying from 0.1 part to 10 parts of surfactant to 500 parts water), or different surfactants may be used, without loss of generality in practicing the invention.

In one embodiment of the invention, the surfactant is provided in a reservoir, and is mixed into the contents of the main reservoir after filling, such as by pump circulation action, or replenished periodically during operation.

In one embodiment of the invention, the scrub tray reservoir 130 may be formed with a bottom surface from a perforated plate having with a sufficient number of apertures to have approximately 50% porosity, with the apertures being circular holes in the range of ⅛″ to ¼″ in diameter.

In one embodiment of the invention, the treatment chamber may be in the range of 12 to 24 inches in width and 6 to 24 inches in depth, with the demister pad placed within this width and depth and with a thickness of 1 to 4 inches. Although many commercially available demister pad types are available, in one embodiment of the invention, the demister pad is approximately 2 inch thick and made from a mold-resistant material which promotes the aggregation of airborne particles into drips of fluid removed by gravity, the demister material including fibrous materials, with the demister pad material packed into a metal frame with wire supports every 4 inches to contain the demister pad material.

In one embodiment of the invention, the distribution grid provides slightly higher air resistance than the demister, and in one example is provided by sheet metal having apertures uniformly distributed over the surface, such as approximately 50% porosity produced by drilling or stamping holes of diameter range ⅛ inch to ¼ inch.

The embodiments described herein are for example purposes only, and are not intended to limit the scope of the claims. As is clear to one skilled in the art, many different variations of pre-wet section, passageway aspect ratios, sizes, materials, and fluids can be used in the practice of the invention described herein, and the examples shown are provided only for clarity of the invention and do not limit the scope of the invention to only the examples shown.

What is claimed is:

1) An air scrubber having:
an inlet passageway for the introduction of outside air or inside air;
a pre-wet passageway for the introduction of fluid from a pre-wetter, the pre-wet passageway providing an airflow direction in the same direction as fluid from said pre-wetter, the pre-wet passageway passing over an airflow barrier formed by the surface of a main reservoir, the airflow directed upwards thereafter;
a scrub tray section having a perforated plate with one surface coupled to said pre-wet passageway and an opposing top surface forming the bottom of a scrub reservoir, the scrub reservoir having a scrub tray dam for spilling excess fluid to said main reservoir, the scrub tray fed from the overflow of a gutter reservoir;
a demister pad positioned above said scrub reservoir, the volume enclosed by said scrub tray and said demister pad forming a scrub chamber;
a distribution grid positioned above said demister pad, the distribution grid having a plurality of apertures forming a higher flow resistance than said demister pad;
a blower for moving air from said air inlet, through said pre-wet section, through said scrub chamber, and to an air outlet.

2) The air scrubber of claim 1 where said pre-wet passageway has an aspect ratio greater than 4.

3) The air scrubber of claim 1 where said pre-wetter is a pressurized pipe containing said fluid, said pipe substantially perpendicular to said inlet air flow and said pipe having apertures which cause fluid to wet said inlet air duct.

4) The air scrubber of claim 1 where said fluid is water and a surfactant.

5) The air scrubber of claim 1 where said fluid is water with a surfactant concentration on the order of 1 part surfactant in 500 parts water.

6) The air scrubber of claim 1 where said scrubber plate has a plurality of holes with a diameter in the range of ⅛″ to ¼″

7) The air scrubber of claim 1 where said demister pad is formed from a mold resistant, fibrous material.

8) An air scrubber having an air inlet accepting contaminated air and an air outlet emitting cleaned air, the scrubber having:
a blower for forcing air from said air inlet to said air outlet;
a pre-wet section having a first section for releasing a fluid for application to a passageway carrying said contaminated air and directing said contaminated air and fluid mixture substantially downward to the surface of a reservoir, said mixture thereafter directed upward to a scrubber;
said scrubber having a perforated plate with a lower surface coupled to said fluid mixture, said scrubber having a scrubber reservoir formed by the upper surface of said perforated plate, said scrubber reservoir having a reservoir dam for spilling excess fluid and collected contaminants to said main reservoir, said scrubber reservoir replenished by the spillover from a gutter reservoir, said gutter reservoir filled with a fluid by at least one gutter fill orifice, said perforated plate forming said contaminated air travelling in jets formed by each perforation in said perforated plate said jets passing through said scrubber reservoir and putting at least some of said contaminants into said fluid;
a demister positioned generally above said scrubber and forming a scrubber chamber, said demister separating airborne fluid droplets passing through said demister, said demister aggregating said fluid droplets and returning said fluid to said main reservoir or said scrubber reservoir, said demister including a flow equalizer comprising a perforated plate proximal to said demister and opposite said scrubber chamber;
said air outlet coupled to the output of said demister.

9) The air scrubber of claim 8 where said pre-wet passageway has an aspect ratio greater than 4.

10) The air scrubber of claim 8 where said pre-wetter is a pressurized pipe containing said fluid, said pipe substantially perpendicular to said inlet air flow and said pipe having apertures which cause said fluid to wet said inlet air duct and contaminants in said contaminated air.

11) The air scrubber of claim 8 where said fluid is water and a surfactant.

12) The air scrubber of claim 8 where said fluid is water with a concentration of surfactant on the order of 1 part surfactant to 500 parts water.

13) The air scrubber of claim 8 where said scrubber plate has a plurality of holes with a diameter in the range of ⅛ inch to 1/4 inch.

14) The air scrubber of claim 8 where said demister pad is formed from a mold-resistant material.

15) A process for scrubbing contaminated air and producing clean air, the process having the steps:
a first step of directing said contaminated air through a passageway having an enhanced surface are and through a pre-wetter for wetting said passageway and producing a stream of pre-wet contaminated air;
a second step of directing said pre-wet contaminated air toward the surface of a main reservoir;
a third step of thereafter directing said pre-wet contaminated air upward to the bottom surface of a scrubber, the scrubber having a substantially planar bottom surface containing a plurality of apertures coupled to an opposing upper surface which forms a scrubber reservoir, said pre-wet contaminated air passing through said apertures and forming a plurality of jets in said scrubber reservoir, thereby producing a scrubber discharge comprising a mixture of contaminants in said fluid and a mixture of air and airborne droplets;
a fourth step of coupling said mixture of contaminants in said fluid to said main reservoir or said scrubber reservoir, and coupling said mixture of air and airborne droplets to a demister for separating said fluid, thereby producing said clean air;
whereby said main reservoir includes a pump for circulating said fluid to said pre-wetter and also to said scrubber reservoir through a gutter reservoir for spilling said fluid onto said scrubber reservoir.

15) The process of claim 14 where said passageway has an aspect ratio greater than 4.

16) The process of claim 14 where said fluid is water mixed with a surfactant.

17) The air scrubber of claim 1 where said fluid is a solution of 0.1 to 10 parts potassium pyrophosphate to 500 parts water.

18) The air scrubber of claim 1 where said scrubber plate has a plurality of holes with a diameter in the range of ⅛ inch to ¼ inch.

19) The air scrubber of claim 1 where said demister pad is formed from a mold resistant material which aggregates airborne water droplets.
